(19) United States
(12) Patent Application Publication
(10) Pub. No.: US 2009/0321993 A1
(43) Pub. Date: Dec. 31, 2009

(54) PROCESS FOR PRODUCING CERAMIC FIBER BOARD

(76) Inventor: Yohei Fukino, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/296,343

(22) PCT Filed: May 7, 2007
(86) PCT No.: PCT/JP2007/059467

§ 371 Date: Mar. 23, 2009

(30) Foreign Application Priority Data
May 8, 2006 (JP) 2006-128969

(51) Int. Cl. B29C 51/00

(52) U.S. Cl. 264/319

(57) ABSTRACT

In order to provide a ceramic fiber board which does not emit smoke and does not cause a problem of shedding of particles even when used in a high-temperature environment, the invention provides a method of producing a ceramic board which uses ceramic fibers containing Al₂O₃ and SiO₂ as a raw material, in which a mixed liquid (Na₂O×3SiO₂) of SiO₂ sol and water glass is used as an inorganic binder, in which weight ratio in terms of the solid contents of SiO₂ and water glass is SiO₂: 89 to 35% and water glass: 11 to 65%.

### BACKGROUND OF THE INVENTION

1. Field of the Invention

The present invention relates to a process for producing a ceramic fiber board which does not emit smoke even when used in a high-temperature environment. The ceramic fiber board is utilized as a lining material of a high-temperature furnace, a construction material or the like.

2. Description of the Related Art

Conventionally, a ceramic fiber board using ceramic fibers as a raw material is used as a lining material of a high-temperature furnace, a construction material or the like.

In general, such a ceramic fiber board is frequently produced by a vacuum forming method.

In the vacuum forming method, ceramic fibers are first dispersed in water. An inorganic binder SiO₂ sol is added. An organic binder is further added to agglomerate the ceramic fibers and the SiO₂ sol. The agglomerated floc is poured into a mold, and molded in vacuo. After molding, a ceramic fine board as a product is obtained through each step of demolding, drying, burning and processing.

In the above vacuum forming method, an organic binder was used, but a production method which does not use an organic binder is present as shown in Patent Document 1.

Patent Document 1: JP-A-2000-317919 (page 1 and FIG. 1)

### DISCLOSURE OF THE INVENTION

### Problems that the Invention is to Solve

However, the problems described hereinafter occur in the ceramic fiber board produced by a method using an organic binder as above.

(1) Because an organic binder is contained in a ceramic fiber board, black smoke is generated when the product is used in a high-temperature environment.

(2) There is the problem that particles are fallen off (shedding of particles) when touching a ceramic fiber board.

(3) Where ceramic fiber boards are contacted with each other and allowed to stand in a high-temperature environment for a long period of time (for example, 1,200° C. for 24 hours), there is the problem that a degree of shrinkage of the ceramic fiber board is large.

(4) Because of a small hardness, there is the case to be difficult to handle.

To respond to the above problems, there is a method in which a ceramic fiber board is previously burned to remove an organic binder, and additionally, the surface of the ceramic fiber board is coated with SiO₂ sol. However, this method gives rise to other problems that the cost is very increased, and production deadline is prolonged.

On the other hand, the method described in Patent Document 1 does not use an organic binder, and therefore, the problem of smoke generation can be solved. However, boron is added in the course of the production, and this gives rise to another problem that a ceramic fiber board itself becomes brittle.

### SUMMARY OF THE INVENTION

The present invention has been made to solve the above problems, and has an object to provide a production method that can produce a ceramic fiber board which does not emit smoke even when used in a high-temperature environment, does not involve the problem of shedding of particles, and has a small degree of shrinkage.

### Means for Solving the Problems

To solve the above problems, the process for producing a ceramic fiber board of the present invention is realized as follows.

The process for producing a ceramic fiber board of the present invention is a process for producing a ceramic fiber board, which uses ceramic fibers containing Al₂O₃ and SiO₂ as a raw material, characterized in that a mixed liquid of SiO₂ sol and water glass (Na₂O×3SiO₂) is used as an inorganic binder, and a weight ratio in terms of solid contents of SiO₂ sol and the water glass as the inorganic binder is that SiO₂ is 89 to 35% and the water glass is 11 to 65%.

In the process for producing a ceramic fiber board of the present invention, ceramic fibers containing Al₂O₃ and SiO₂, and a mixed liquid as an inorganic binder in which a weight ratio in terms of solid contents of SiO₂ sol and the water glass is that SiO₂ is 89 to 35% and the water glass is 11 to 65%, are dispersed in water, and molded into a plate shape, and the plate-shaped molding is dried by heating.

In the process for producing a ceramic fiber board of the present invention, it is further desired that the ceramic fibers are such that the ratio of Al₂O₃:SiO₂ is 46:54.

### Advantage of the Invention

According to the process for producing a ceramic fiber board of the present invention, in producing a ceramic fiber board using ceramic fibers containing Al₂O₃ and SiO₂ as a raw material, the ceramic fibers containing Al₂O₃ and SiO₂, and a mixed liquid as an inorganic binder in which a weight ratio in terms of solid contents of SiO₂ sol and the water glass is that SiO₂ is 89 to 35% and the water glass is 11 to 65%, are dispersed in water, followed by molding into a plate shape, and the plate-shaped molding is dried by heating. Therefore, the ceramic fiber board does not contain an organic binder. As a result, smoke generation does not occur even when used in a high-temperature environment, and because adhesive strength of a SiO₂-rich glass containing a small amount of Na₂O is large, strength and hardness are high and shedding of particles hardly occurs.

When the ceramic fibers have Al₂O₃:SiO₂ ratio of 46:54, better result is obtained in the points of smoke generation in a high-temperature environment, the problem of shedding of particles, and a degree of shrinkage.

### BRIEF DESCRIPTION OF THE DRAWINGS

FIG. 1 is a process view showing production processes of a ceramic fiber board of a first embodiment of the present invention.

FIG. 2 is a flow chart showing production processes of the ceramic fiber board of the first embodiment of the present invention.

FIG. 3 is an explanatory view showing evaluation results of the ceramic fiber board of the first embodiment of the present invention.

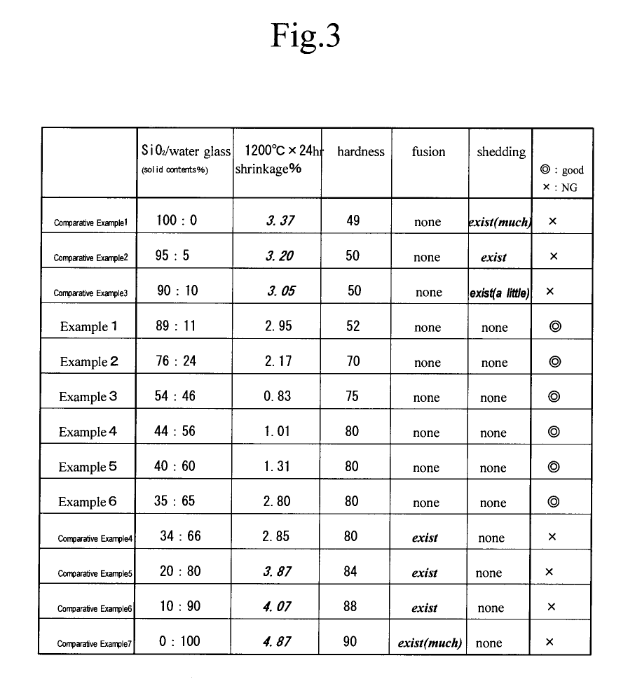

### DETAILED DESCRIPTION OF THE INVENTION

The best mode for carrying out the present invention (hereinafter, the embodiment) is described in detail below by reference to the drawings.

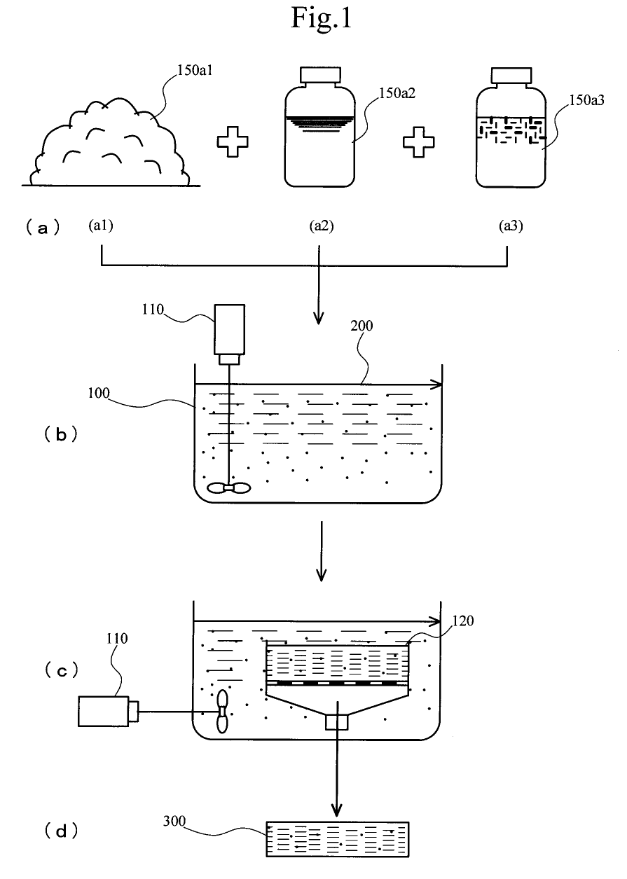

The process for producing a ceramic fiber board as a first embodiment is described in the order of each step using explanatory views of FIG. 1 and the subsequent drawings.

[Step (a)]

First, ceramic fibers 150a1, water glass 150a2 and SiO₂ sol 150a3 are provided. Here, 200 g of ceramic fibers (Al₂O₃: 46%, SiO₂: 54%, average fiber length: 3 mm, average fiber diameter: 3.0 mm) is provided (FIG. 1(a1)). Furthermore, 20 liters of an aqueous solution having a solid content of 10% is prepared so as to be SiO₂ sol: water glass (solid content)=(100 to 0):(0 to 100) (FIGS. 1(a2), (a3)).

[Step (b)]

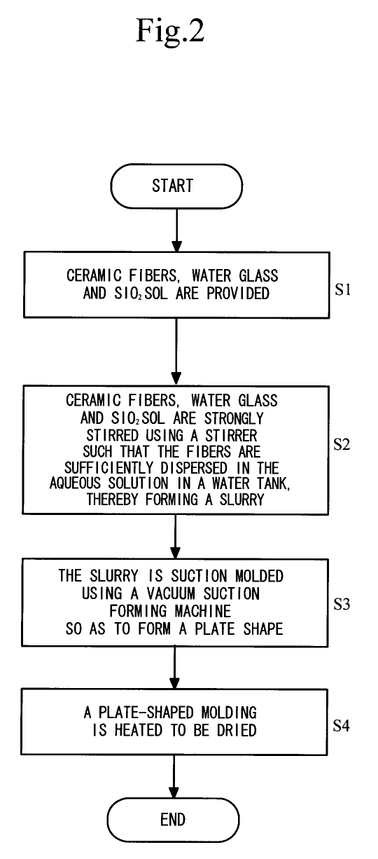

200 g of the ceramic fibers (Al₂O₃: 46%, SiO₂: 54%, average fiber length: 3 mm, average fiber diameter: 3.0 mm) is blended in the above aqueous solution (FIG. 1(a) and step S1 in FIG. 2) to disperse (FIG. 1(b) and step S2 in FIG. 2).

In this case, the resulting mixture is strongly stirred using a stirrer 110 such that the fibers are sufficiently dispersed in the aqueous solution in a water tank 100, thereby forming a slurry 200. The slurry used herein means a suspension in which fine solid particles are suspended in water.

[Step (c)]

The slurry 200 is suction molded using a vacuum suction forming machine 120 so as to form a plate shape (FIG. 1(c) and step S3 in FIG. 2). In this embodiment, the slurry is directly suction molded using the vacuum suction forming machine 120 so as to form a plate shape having 200 mm long, 200 wide and 25 mm thick.

[Step (d)]

A plate-shaped molding 300 obtained by the suction molding with the vacuum suction forming machine 120 is taken out, heated to 120° C. to be dried (FIG. 1(d) and step S4 in FIG. 2).

In this case, burning using a burning furnace is not used, but drying by heating is used. When an electric drying furnace is used for drying by heating, drying by heating at 120° C for 12 hours is conducted. Furthermore, when a microwave drying furnace using microwaves is used, drying by heating for about 1 hour may be conducted.

Moldings 300 (bulk density: 0.23 g/cm³) having variously changed weight ratios in terms of solid contents of SiO₂ sol and water glass are prepared. When those moldings are examined on a degree of shrinkage at 1,200° C. for 24 hours, a degree of fusion, hardness at room temperature and a degree of shedding of particles, the results shown in Table 3 are obtained.

In Examples 1 to 6 in which the weight ratios in terms of solid contents of SiO₂ sol and water glass are in a range of (89:11) to (35:65), “good” results were obtained in all of the degree of shrinkage, hardness, fusion and shedding of particles. In other words, comprehensively, products satisfying targeted performances as a ceramic fiber board were obtained in Examples 1 to 6.

Furthermore, in Comparative Examples 1 to 3 in which the weight ratios in terms of solid contents of SiO₂ sol and water glass are in a range of (100:0) to (90:10), “poor” results were obtained in the degree of shrinkage (3% or more) and shedding of particles (observed). In other words, comprehensively, targeted performances as a ceramic fiber board were not satisfied in Comparative Examples 1 to 3.

Furthermore, in Comparative Example 4 in which the weight ratio in terms of solid contents of SiO₂ sol and water glass is in a range of 34:66, “poor” result was obtained in the point of fusion (observed). In other words, comprehensively, targeted performances as a ceramic fiber board were not satisfied in Comparative Example 4.

Furthermore, in Comparative Examples 5 and 6 in which the weight ratios in terms of solid contents of SiO₂ sol and water glass are in a range of (20:80) to (0:100), “poor” results were obtained in the degree of shrinkage (3% or more) and fusion (observed). In other words, comprehensively, targeted performances as a ceramic fiber board were not satisfied.

Here, the above experimental results are considered.

To solve the above-described problems, the present embodiment uses a mixed binder of SiO₂ sol and water glass.

In general, it has conventionally been believed that when water glass is used, heat resistance of a fiber molding deteriorates, that is, a degree of shrinkage at a high-temperature is increased. For this reason, water glass has not conventionally been used in a fiber molding.

However, the present inventors carried out extensive and intensive investigations, and found that, as a result of experiments using formations of various mixed binders of SiO₂ sol and water glass, although moldings obtained by using general SiO₂ sol and an organic binder have the degree of shrinkage of 3.0% or more at 1,200° C. for 24 hours, only the moldings obtained in the case of a weight ratio in terms of solid contents of SiO₂ sol and water glass in a range of (89:11) to (35:65) have the degree of shrinkage of 2.9% or less at 1,200° C. for 24 hours, and satisfy all the items of hardness, fusion and shedding of particles.

It has further turned out as a result of experiments that the fiber molding obtained by the production method of the present embodiment does not contain an organic material, has a small degree of shrinkage and high hardness, is hard to generate shedding of particles or dusts, and thus is a very excellent product.

The reasons that the degree of shrinkage at 1,200° C. for 24 hours becomes small in Examples 1 to 6 are considered as follows.

The surface of the ceramic fibers is coated with the mixed binder of SiO₂ sol and water glass, and the composition of the coating contains a small amount of Na₂O and is a SiO₂-rich glass. Therefore, the coating reacts with ceramic fibers (Al₂O₃:SiO₂=46:54) at a high-temperature, and SiO₂-rich glass is formed in the composition of the surface of ceramic fibers, resulting in preventing mullite crystallization of fibers to a certain extent.

A primary cause of shrinkage of ceramic fibers is mullite crystallization of a glass having Al₂O₃:SiO₂=46:54. Density of the glass having Al₂O₃:SiO₂=46:54 is about 2.6 g/cm³ while density of the mullite crystals is 3.2 g/cm³, and shrinkage occurs by the increase of density.

As a result of X-ray analysis of the molding containing water glass 0% (SiO₂=100%) and the molding containing water glass 46% (SiO₂=54%) after heat-treated at 1,200° C. for 24 hours, it turned out that density of crystal phase of mullite of water glass 0% is considerably larger than that of water glass 46%.

In other words, it is considered that crystallization of mullite is suppressed due to the increase of the amount of water glass, and shrinkage is decreased. On the other hand, because the SiO₂-rich glass containing a small amount of Na₂O has a large adhesive strength, the obtained molding has high strength and hardness, and is hard to generate shedding of particles or dusts.

Furthermore, it was confirmed in Comparative Examples 1 to 3 that shedding of particles is increased according to the decrease of the content of water glass.

It was newly found out from the above points that only in the case that the weight ratio in terms of solid contents of SiO₂ sol and water glass is (89:11) to (35:65), the degree of shrinkage of the moldings at 1200° C. 24 hours becomes 2.9% or less, all the items of hardness, fusion and shedding of particles are satisfied, and good effects that have not conventionally been recognized to be critically significant limits can be achieved. In other words, it has turned out that a ceramic fiber board which does not emit smoke even when used in a high-temperature environment, does not generate the problem of shedding of particles, and has a small degree of shrinkage can be produced.

The above embodiment can be used as a process for producing a ceramic fiber board which does not emit smoke even when used in a high-temperature environment. The ceramic fiber board is utilized as a lining material of a high-temperature furnace, a construction material, or the like.

1. A process for producing a ceramic fiber board, comprising steps of:
dispersing a ceramic fiber containing Al₂O₃ and SiO₂, and an inorganic binder wherein the weight ratio in terms of solid contents of a SiO₂ sol and a water glass (Na₂O×3SiO₂) is that said SiO₂ is 89 to 35% and said water glass is 11 to 65% in water;
molding said ceramic fibers and said inorganic binder; and
drying said mold by heating.

2. A process for producing a ceramic fiber board, comprising steps of:
dispersing a ceramic fiber containing Al₂O₃ and SiO₂, and an inorganic binder wherein the weight ratio in terms of solid contents of a SiO₂ sol and a water glass (Na₂O×3SiO₂) is that said SiO₂ is 89 to 35% and said water glass is 11 to 65% in water;
molding said ceramic fibers and said inorganic binder into plate shape; and
drying said plate-shaped mold by heating.

3. A process for producing a ceramic fiber board according to claim 1,
wherein the ratio of Al₂O₃:SiO₂ of said ceramic fibers is 46:54.

4. A process for producing a ceramic fiber board according to claim 2,
wherein the ratio of Al₂O₃:SiO₂ of said ceramic fibers is 46:54.
